(19) United States
(12) Patent Application Publication
(10) Pub. No.: US 2007/0279219 A1
(43) Pub. Date: Dec. 6, 2007

(54) Electronic proximity alarm device

(76) Inventor: Gerald E. Warriner, West Melbourne, FL (US)

Correspondence Address: GERALD E. Warriner, 9037-H York Lane, West Melbourne, FL, 32904, US

(21) Appl. No.: 11/545,882

(22) Filed: Oct. 11, 2006

Related U.S. Application Data
(60) Provisional application No. 60/810,950, filed on Jun. 5, 2006.

(51) Int. Cl. G08B 1/08; G08B 23/00

(52) U.S. Cl. 340/539.23; 340/573.4

(57) ABSTRACT

An Electronic Proximity Alarm Device comprised of a housing that covers and protects one or more electronic and mechanical components that are assembled within the housing and that are electronically programmed in such manner as to wirelessly determine whether a Device worn by a habitual criminal on parole or probation is within given minimum allowable proximity of a potential victim that is wearing a corresponding Device, in which case an alarm is triggered for the purpose of notifying both users of the Devices as well as law enforcement agencies, law enforcement officers and corresponding third parties that a proximity breach is in progress at a specific place, in a specific direction and at specific distances from each of the corresponding Devices, thus activating immediate response, thereby possibly preventing a criminal act.

### CROSS-REFERENCE TO RELATED APPLICATIONS

This application claims the benefit of provisional patent application Ser. No. 60/810,950 filed Jun. 5, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

The current art invention identified in the title above relates to electronic wireless proximity alarm devices, systems and programs.

2. Prior Art

### Assertion

No prior art has provided an electronic proximity alarm device with the means of determining the distance between its self and one or more corresponding devices for the purpose of alerting wearers and third-parties that a given minimum allowable proximity has been breached at a specific location so that law enforcement agencies and personnel may immediately respond in order to possibly prevent a criminal act.

The Electronic Proximity Alarm Device may generate modification of existing laws and the implementation of new federal, state or municipal laws, codes or ordinances; however, private use for security and protection purposes is allowable under the law.

### Utilization of Prior Art

The current art is comprised of a housing that may be manufactured in an unlimited variety of forms, shapes, sizes, materials and finishes wherein numerous mechanical and non-mechanical components may be covered and protected.

Each component has been known, manufactured, advertised, published, merchandised and patented in one form or another prior to Sep. 16, 1985, therefore providing proof of their uniqueness at the time they were patented as well as their usefulness and manufacturability. Consequently, the applicant has no negative comments with regards to prior art listed below.

The listing below is only for the purpose of validating the statement in the above paragraph.

Not all components will be utilized in every housing and the housings may contain additional components other than just those included in the claims of this application.
1. Alphanumeric Pager, U.S. Pat. No. 3,976,995—Aug. 24, 1976;
2. Atomic Clock, U.S. Pat. No. 4,290,030—Sep. 15, 1981;
3. Cell Phone, U.S. Pat. No. 4,485,486—Nov. 27, 1984;
4. Computer and Computer Programming, U.S. Pat. No. 3,932,866—January 1976;
5. Digital Camera with or without video capability, U.S. Pat. No. 4,191,459—Mar. 4, 1980;
6. Electronic Calculator, U.S. Pat. No. 3,946,216—Mar. 23, 1976;
7. Electrical circuitry, Battery operated transmitter circuit—U.S. Pat. No. 4,056,815—Nov. 3, 1977;
8. Electronic lock, U.S. Pat. No. 4,031,434—Jun. 21, 1977;
9. Electronic Mail, U.S. Pat. No. 4,106,060—August 1978;
10. Electrical body-movement power generator, U.S. Pat. No. 4,008,566—Feb. 22, 1977;
11. Electronic programmable on or off switch, U.S. Pat. No. 3,931,475—Jan. 6, 1976;
12. Engraving, U.S. Pat. No. 3,946,491—Mar. 30, 1976;
13. Electronic proximity device, U.S. Pat. No. 4,460,889—Jul. 17, 1984;
14. Global Positioning System (GPS), U.S. Pat. No. 4,468,793-Aug. 28, 1984;
15. Housing; “something that covers or protects” Webster's Collegiate 5^{th} Ed. 1943;
16. Liquid crystal display (LCD), U.S. Pat. No. 3,939,556—Feb. 24, 1976;
17. Loudspeaker, U.S. Pat. No. 3,935,402, Jan. 27, 1976;
18. Pager with escalating audio alert signal level, U.S. Pat. No. 4,237,448—Dec. 2, 1980;
19. Radio, location by triangulation, U.S. Pat. No. 3,988,734—Oct. 26, 1976
20. Radio transmitters, receivers, U.S. Pat. No. 4,163,977—Aug. 7, 1979;
21. Rechargeable electrical power source (battery), U.S. Pat. No. 4,163,977—Aug. 7, 1979;
22. Secure communication system, U.S. Pat. No. 4,171,513—Oct. 16, 1979;
23. Talking solid state device, U.S. Pat. No. 3,952,169—Apr. 20, 1976;
24. Telegraphy, U.S. Pat. No. 3,932,711—Jan. 13, 1976;
25. Text to speech conversion for the blind, U.S. Pat. No. 3,704,345—Nov. 28, 1972;
26. Touchscreen, U.S. Pat. No. 4,521,870—Jun. 4, 1985;
27. Tracking & position determination system, U.S. Pat. No. 4,060,809—Nov. 29, 1977;
28. Transmitter circuit, U.S. Pat. No. 4,056,815—Nov. 1, 1977;
29. Vibration pager, mechanical vibration generator, U.S. Pat. No. 3,786,628—Jan. 22, 1974;
30. Wireless Alarm System, U.S. Pat. No. 4,157,540—Jun. 5, 1979; and
31. Wireless Signal, U.S. Pat. No. 4,511,887—Apr. 16, 1985.

### Integration of Prior Art

The following listing includes, but does not limit prior art as well as other elements utilized in the Electronic Proximity Alarm Device wherein the invention is comprised of:
1. a housing that covers and protects one or more electronic and mechanical components that are assembled within the housing and that are electronically programmed in such manner as to wirelessly determine whether one and another of the Devices are within given minimum allowable proximity of each other, in which case an alarm is triggered for the purpose of notifying users of the Devices and corresponding third parties that a proximity breach is in progress at a specific place, in a specific direction and at specific distances from each of the corresponding and third-party Devices.
2. an unlimited number of Electronic Proximity Alarm Device Units and Models of unlimited numbers of sizes, shapes, finishes and materials of manufacture including, but not limited to those that may circumscribe human and other animal body parts such as necks, wrists, waists and ankles as well as those that may be transportable or fixed-in-place.
3. one or more radio technology devices, electronic circuits, systems and programs capable of wirelessly transmitting and receiving signals and messages to and from corresponding Electronic Proximity Alarm Devices and third party Devices.
4. a rechargeable electrical power source such as, but not limited to Voltaic Cells, a power source that provides electrical energy generated by body movement, solar power or alternative sources of electrical power.
5. computer hardware and software, but not limited to electronic microprocessors, computer chips, programmable software, and programs specifically relating to the operations of electronic and mechanical components within the Electronic Proximity Alarm Device housing.
6. one or more electronic and mechanical alarm devices, programs and systems including, but not limited to vibration and audio alarm capabilities;
7. at least one global positioning system, GPS, including, but not limited to an atomic clock and computer programs that utilize the global positioning system.
8. one or more electrical circuitry layouts and one or more placement relationships of components located within the housing.
9. a panic button with a pressure sensitive capability and an electronic means of alerting third party corresponding devices utilizing direct radio transmissions, relay towers and GPS to contact police and other emergency services.
10. a panic button that utilizes a cellular phone to contact police and other emergency services.
11. a Liquid Crystal Display or a Touchscreen Display mounted on or let into the surface of the Electronic Proximity Alarm Device housing whereby the direction and distance of one or more corresponding Devices may be displayed together with additional information written in one or more languages or, alternatively the same information described verbally in one or more languages to accommodate the blind.
12. an inquiry button including, but not limited to a pressure sensitive device and an electronic switch for the purpose of determining the location of a corresponding Electronic Proximity Alarm Device.
13. a software program whereby each component within the Electronic Proximity Alarm Device housing may be turned on or off independently of the other components.
14. engraved information on the exterior of the housing identifying the name, address and telephone number of the wearer of a specific Electronic Proximity Alarm Device.
15. one or more electronic ports to accommodate other electronic devices and accessories including, but not limited to recharging a voltaic cell.
16. an electronic calculator programmed to utilize information received from wireless transmissions including, but not limited to the global satellite positioning system, direct radio broadcasts based on strength of signals and radio transmission triangulation programs for the purpose of determining the distance between two or more Electronic Proximity Alarm Devices, perimeter dimensions of specific areas within three or more GPS coordinates and further determining where one or more Electronic Proximity Alarm Devices are at a given time and date for tracking and recording where one or more Electronic Proximity Alarm Devices have been at any prior time and date.
17. one or more electronic software programs capable of sending and receiving messages, data and commands to and from corresponding Electronic Proximity Alarm Devices and third-party corresponding devices including, but not limited to law enforcement agencies, law enforcement officers, detectives and proprietary data banks.
18. an electronic alphanumeric pressure sensitive keyboard pager; and
19. a digital camera with video capability.

### OBJECTS AND ADVANTAGES

The invention, when utilized, is anticipated to provide numerous accomplishments and advantages including, but not limited to those that are intended to provide means, methods and systems, whereby:
1. separation between law-offenders and potential victims is maintained by alerting both parties when they are within given minimum allowable proximity of one-another, thereby allowing them to increase the distance between them to avoid a proximity incident that might result in an illegal act;
2. potential victims, law enforcement agencies and officers may be alerted that habitual criminals such as parolees, arsonists, vandals, pedophiles, stalkers, shoplifters, robbers, home invaders, rapists, and other such offenders are within forbidden proximity of places such as schools, playgrounds, video game arcades, department stores and all-night food stores, thereby allowing immediate response by authorities for protecting those at risk;
3. police agencies, officers and third-party correspondents are alerted when a proximity event is in progress at a precise location, distance and direction from their locations, thus allowing immediate response, thereby possibly averting a criminal act;
4. separation between gang members in the same gang as well as members of other gangs may be maintained, thereby diluting the effectiveness of such gangs;
5. separation between sexual deviates such as habitual rapists, pedophiles, molesters and abusers may be maintained, thereby deterring relationships that might encourage and escalate illicit behavior;
6. criminal behavior may be reduced by electronically monitoring habitual law offenders under court order, thereby providing greater protection for law-abiding persons;
7. the investigation of criminal activity may be assisted, thereby improving operations and effectiveness of law enforcement agencies and personnel;
8. law enforcement parole officers, probation officers and detectives may track and monitor habitual offenders that are under court order or other legal edicts, thereby limiting their illegal opportunities;
9. non-criminals wearing the Electronic Proximity Alarm Device may summon immediate help by use of a panic button built into the Device;
10. a court may be empowered to offer a felon, person on probation or other offenders a choice of incarceration or release contingent on the provision that he or she must wear the Electronic Proximity Alarm Device for the duration of their probation, parole or court proceedings, thereby potentially reducing the number of inmates that will be in prisons as well as reducing the cost of maintaining prison facilities and the costs of feeding and caring for prisoners;
11. habitual criminals may be denied access to specific places such as particular businesses, homes, parks, schools and the like, thereby shielding potential victims from criminal acts, thus reducing financial losses, damages, injuries and deaths;
12. persons who may otherwise be distressed due to being at risk may be shielded and protected, thereby gaining some piece of mind and a greater sense of well being;
13. habitual DUI offenders may be deterred from entering places that sell or serve intoxicating beverages, thereby reducing accidents, injuries and deaths;
14. emergency alerts are immediate, thereby improving response time and helping people survive;
15. a parent, guardian or care-person may be assured that those they seek to protect and care for have more protection than they alone can provide, thereby easing their concerns and providing them with less stress and a greater sense of well-being;
16. habitual offenders under court order or other legal edicts may be monitored by their parole officers, police officers and other law enforcement officials authorized to do so including, but not limited to local police, sheriff deputies, highway patrol personnel, the FBI, CIA, AFT and HAS, thereby being able to track their travels to determine who may have been responsible for a given illegal act;
17. persons in harms way including, but not limited to armed services personnel that are missing in action, downed pilots and crew-members, persons lost at sea, abducted children, run-a-ways, travelers in foreign lands, diplomats and dignitaries may be quickly located, thereby improving the possibility of their recovery;
18. the Device automatically will notify law enforcement agencies and personnel when it is tampered with, therefore any habitual criminal that attempts to compromise the Device for the purpose of fleeing jurisdiction will be denied success due to the authorities immediate notice and their quick response;
19. an alarm is broadcast when a habitual shop-lifter or a habitual robber enters a store, a habitual bank robber enters a bank, a habitual horse or cattle thief enters a ranch or farm, a habitual drunk and disorderly alcoholic enters a bar or liquor store, a habitual burglar or home invader enters a home, law enforcement agencies and officers are simultaneously notified, thereby generating immediate response to thwart an illegal act that the criminals have habitually performed in the past;
20. municipalities may decrease the numbers of criminals living within their jurisdiction as a result of requiring them to wear Electronic Proximity Alarm Devices;
21. authorities may pass laws or ordinances that will decrease crime, decrease the number of prisons and prisoners, improve the ability and effectiveness of law enforcement agencies and law enforcement personnel, increase security of individuals and groups of people, businesses, properties and homes and save lives, decrease accidents, reduce pain and suffering and reduce loss of time and money;
22. An Electronic Proximity Alarm Device Unit may not be allowed to come within given minimum allowable proximity of another Unit, thereby limiting contact between habitual criminals.

### SUMMARY

The current art is comprised of numerous components that have been known, manufactured, merchandised, published previously or patented in one way or another and are assembled within a housing that covers and protects them for the purpose of providing law enforcement agencies and law enforcement officers with useful means, methods and systems of shielding and assisting innocent persons from criminal acts perpetrated by habitual law offenders, whereas parolees, felons, abusers and perpetrators who are under court order or other legal edicts may be deterred from coming into certain defined proximity of potential victims and additionally, providing law enforcement officials such as parole officers and detectives with methods of monitoring and tracking the activities of parolees and those on probation, thereby improving and simplifying the operations and procedures of law enforcement, thus over time reducing the number of prisons and prisoners as well as reducing the costs associated with incarceration.

### BRIEF DESCRIPTION OF THE DRAWINGS

Herein, for clarity, the Electronic Proximity Alarm Device is referred to as ‘EPAD’; a court ordered Electronic Proximity Alarm Device is referred to as a ‘Unit’ and a non-court ordered Electronic Proximity Alarm Device is referred to as a ‘Model’.

The Electronic Proximity Alarm Device (EPAD) will be better understood from the following descriptions thereof in conjunction with the accompanying drawings of which:

FIG. 1 is a schematic drawing of the EPAD Unit being worn by a man in relation to a corresponding EPAD Model atop a barn-shaped building, another corresponding EPAD Model atop another building and a satellite as further related to radio transmissions to and from the related objects;

FIG. 2 is a schematic drawing of a Unit being worn by a man and an EPAD Model being worn by a woman as related to radio transmissions to and from the two Devices as well as to a third party Fixed-in-Place EPAD Model attached to the ceiling of an interior space.

FIG. 3 is a schematic drawing of an EPAD Unit being worn by a man as related to radio transmissions to and from radio transmission relay towers and as to transmissions to and from said relay towers and a third party EPAD Model atop a building;

### DETAILED DESCRIPTION OF THE DRAWINGS

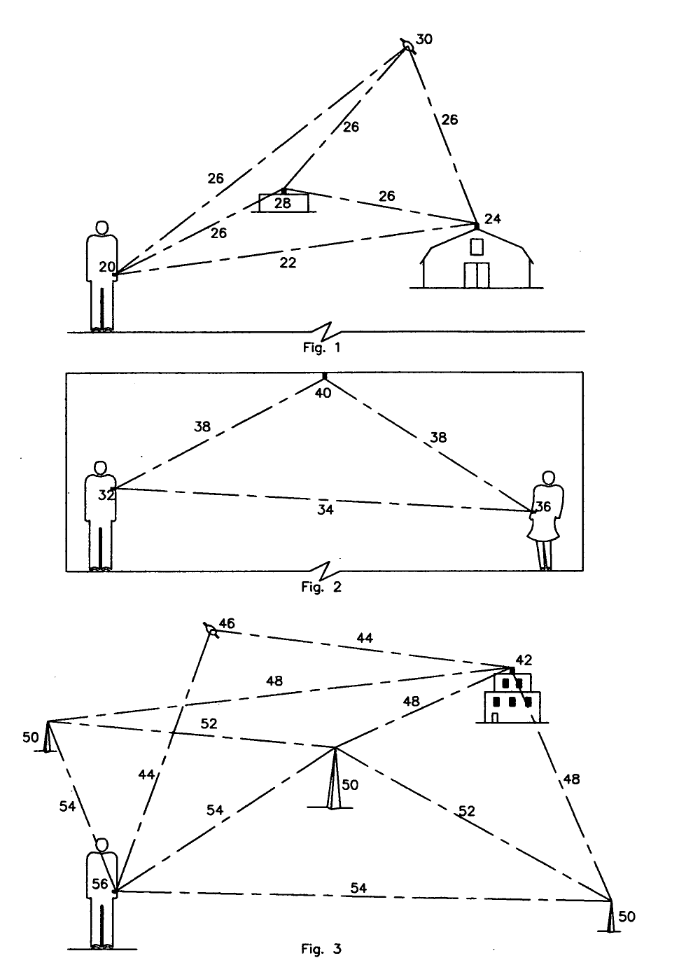

As shown in FIG. 1, the EPAD Unit (20) circumscribing the wrist of a man continuously or intermittently transmits and receives radio signals (22) as does a corresponding Fixed-in Place EPAD Model (24) in order to determine whether the distance between the two devices are within a given minimum allowable distance.

Additionally and redundantly, both devices continuously or intermittently transmit and receive radio signals (26) to and from a Global Positioning System (GPS) satellite (30) in order to determine the same information.

In the event that the EPAD Unit (20) is within the given minimum allowable distance of the Fixed-in-Place EPAD Model (24), both devices will automatically trigger alarms and messages signifying a proximity breach to both devices via transmissions (22) and transmissions (26) to third party corresponding devices (28).

As shown in FIG. 2, the EPAD Unit (32) circumscribing the upper arm of a man continuously or intermittently transmits and receives radio signals (34) as does a corresponding EPAD Model (36) circumscribing the wrist of a women in order to determine whether the distance between the two devices are within a given minimum allowable distance.

In the event that the EPAD Unit (32) is within the given minimum allowable distance of the EPAD Model (36), both devices will automatically trigger alarms and messages signifying a proximity breach to both devices via transmissions (38) and to and from a third party corresponding EPAD Model (40).

As shown in FIG. 3, the Fixed-in-Place EPAD Model (42) atop a building continuously or intermittently transmits and receives radio signals (44) to and from a Global Positioning System (GPS) satellite (46) for the purpose of determining the location of an EPAD Unit circumscribing a man's wrist (56).

Additionally and redundantly, the same Fixed-in-Place Model (42) continuously or intermittently transmits and receives radio signals (48) to and from radio relay towers (50) that in turn continuously or intermittently transmit and receive transmissions (54) to and from the EPAD Unit circumscribing the man's wrist (56).

The schematic drawings are for illustrative purposes only and do not in any way limit the utilization, variations of use or means, methods and systems that are available within the full and broadest scope of the invention.

### DETAILED DESCRIPTION

### Comprising Electronic and Mechanical Components

The current invention is comprised of a housing that covers and protects one or more electronic and mechanical components that have been known, patented and published prior to Sep. 16, 1985 and that are assembled and connected with electrical wiring circuitry to allow them to function synergistically within the housing while utilizing means, methods, systems and programs that have also been known, patented and published prior to Sep. 16, 1985; said components, means, methods, systems and programs being comprised of, but not limited to one or more of each of the following:
1. Afore-mentioned housing;
2. Alphanumeric Pressure Sensitive Keyboard;
3. Alphanumeric Pager:
4. Atomic Clock;
5. Computer Hardware and Software;
6. Digital camera with or without video capability;
7. Electric circuitry;
8. Electrical Power, body-movement Energy Device;
9. Electrical Power, rechargeable Voltaic Cell;
10. Electronic Audio Alarm Device;
11. Electronic Calculator;
12. Electronic Mail;
13. Electronic Programmable on or off switches;
14. Electronic Proximity Device;
15. Engraving;
16. Global Positioning System;
17. Inquiry Button, Pressure Sensitive;
18. Internet access;
19. Liquid Crystal Display;
20. Microprocessor
21. Pager with Escalating Audio Signal Level;
22. Panic Button, Pressure Sensitive;
23. Radio devices including, but not limited to transmitters, receivers, antennas microphones and speakers utilizing radio frequencies;
24. Solid State Talking Device;
25. Touchscreen;
26. Vibration Pager, Mechanical Vibration Generator, Vibration System and Method;
27. Wireless Alarm System; and
28. Wireless Messages and Signals;

### Electronic Proximity Alarm Device or ‘EPAD’

Herein, a single court ordered Electronic Proximity Alarm Device is referred to as ‘Unit’ and a privately owned Electronic Proximity Alarm Device is referred to as ‘Model’.

### Static Physical Properties

All mechanical components of the invention has been known, manufactured, advertised, published, merchandised or patented in one form or another prior to Sep. 16, 1985, thereby conclusively proving their uniqueness at the time they were patented as well as their manufacturability and all such components comprised in the current art may be purchased on the open market in one form or another and may be modified or ordered from manufacturers currently manufacturing such components.

### Non-Mechanical Properties

Each non-mechanical component of the invention has been known, manufactured, advertised, published, merchandised or patented in one form or another prior to Sep. 16, 1985, thereby conclusively proving their uniqueness at the time they were patented as well as their production capability and all such components comprised in the current art may be purchased on the open market in one form or another and may be modified or ordered from producers of such components.

### Adaptation and Utilization

The Electronic Proximity Alarm Device invention has been conceived as a means, method and system that is adaptable to unlimited utilization for the purpose of shielding and protecting persons at risk of being victims of habitual criminals and for the purpose of improving law enforcement operations and effectiveness in that regard.

### Assembly and Production

Each Unit and Model of the invention is comprised of mechanical and non-mechanical components that must be assembled by one skilled in the art of such assembly, all other aspects of the invention having been produced by those persons skilled in the art of making and using said components prior to Sep. 16, 1985 and there are hundreds of thousands, if not millions of persons in the world that are qualified to physically assemble the mechanical components comprising the invention and the same is true as to persons who are sufficiently skilled in computer programming to produce operationally efficient programs required to render the invention useful for the purposes intended.

### Diversity and Explanatory Relationships

Each Unit and Model of the Electronic Proximity Alarm Device is designed, constructed and programmed to meet general, common and specific needs and circumstances as exampled by, but not limited to the following:
1. There are at least three types of Electronic Proximity Alarm Devices including, but not limited to Mobile, Transportable and Fixed-in-Place types;
2. Mobile Units and Mobile Models are to be worn, Transportable Models are to be carried and Fixed-in-Place Models are to be mounted on fixed objects;
3. Models vary as to housings, components, types, sizes, numbers, functions, circuitry, programs and appearance;
4. Court-ordered Units are equipped with mechanical locks that are operated electronically by persons authorized to do so, but they are simplistic and do not include cell phones, cameras, liquid crystal displays, touchscreen displays, keyboards, pagers and inquiry or panic buttons, whereas Models may or may not have a lock, but if they have one, it may be operated by the owner, guardians or parents;
5. Personal Models may contain virtually all available components and may be quite attractive, whereas transportable and fixed-in-place Models may be less attractive.
6. The audio feature may be electronically turned on or off at the discretion of the law enforcement officials wearing or carrying a mobile or transportable Model;
7. Fixed-in-place Models do not have vibrator alarm capability and may or may not have audio alarm capability, but if they do, the volume may be set higher or lower to meet the requirements of the users;
8. Strength of transmission signals may be set by the courts or other legal edicts or by persons authorized to so;
9. Generally, court ordered mobile Units and their corresponding Models should be programmed to have the same transmission strength and range of coverage, however, the court may order stronger strength for one over the other under mitigating circumstances;
10. Court ordered Units may be specifically paired with one or more specific personal or transportable corresponding Models or they may be paired with non-specific fixed-in-place corresponding Models that are programmed to activate when a Unit is within minimum allowable proximity of another Device;
11. One or more transmission means, utilizing one or more radio frequencies each, may be utilized to transmit signals and messages continuously or intermittently as required by the various programs being served within the housing of the Electronic Proximity Alarm Device;
12. One or more transmission methods operating independently or simultaneously may be utilized in determining distances between corresponding EPAD Units and Models including, but not limited to radio transmissions based on signal strength, relay stations, triangulation and global positioning systems;
13. EPAD Units and Models will operate properly indoors and outdoors;
14. Law enforcement agencies should install fixed-in-place monitoring Models with strong signals and strong GPS capabilities;
15. Global Positioning System technology may be utilized to determine the square footage or square mileage within three or more GPS coordinates for the purpose of defining an area wherein specific Units are not allowed.
16. Transmitting and receiving radio devices of all Units and Models include, but are not limited to those that are capable of transmitting and relaying short and long-range radio signals to and from corresponding Units and Models as well as to and from telephonic and satellite relay devices.

### Preferred Embodiment

The current invention is:
1. A System, whereby various proven components are assembled to act synergistically for the purpose of shielding and protecting potential victims and accomplishing other daunting law enforcement goals that would otherwise continue to be unattainable;
2. A Method, whereby opportunities of committing criminal acts are reduced by maintaining separation between habitual criminals and potential victims;
3. A Means, whereby law enforcement agencies and personnel may utilize the Electronic Proximity Alarm Device to improve their operations and effectiveness in combating criminal conduct; and
4. Beneficial and useful, whereby habitual criminals may be deterred from repeating criminal acts, thereby improving security and protection for the populous, animals and property and reducing injuries, deaths, personal and business financial losses and costs of enforcement, incarceration and maintenance of prisons.

Additionally, the preferred embodiment is comprised of three or more secondary embodiments, whereby the secondary embodiments are assembled to form a synergistic system further comprised of numerous Units and Models and unlimited variations as to sizes, shapes, finishes and materials of manufacture, whereas:
1. Three such Secondary Embodiments are;
   a. Mobil Units or Models worn by persons by circumscribing a body part;
   b. Transportable Models carried in a pocket, valise, handbag or other means of conveyance;
   c. Fixed-in-place Models mounted on a fixed object, outdoors as on a fence, post, wall, roof or soffit or indoors, as in a school, school bus, train, sub-way, car, video arcade, department store, all night diners and food stores and hotels.
      Special Note: EPAD Units may only be implemented by court order or other legal edicts; current laws are anticipated to require modifications and new laws may be required to be enacted to allow use of the Electronic Proximity Alarm Device in specific circumstances; however, personal use for protective purpose is allowable.

### More embodiments are probable as time presents additional possibilities.

### Utility and Operation

### Descriptive Scenario

Example #1 of the usefulness and operational effectiveness of the Electronic Proximity Alarm Device.
1. A small city has 5 elementary schools, 2 middle schools, 1 high school and a high number of pedophiles as well as drug pushers, abductors, molesters and other assorted offenders on parole or probation who are known to be abusive to children, so the city council passes three ordinances; one ordinance for the purpose of installing fixed-in-place Electronic Proximity Alarm Devices along the perimeters of each school; a second ordinance for the purpose of requiring all known pedophiles and abusers living within city boundaries to wear mobile Electronic Proximity Alarm Devices and a third ordinance for the purpose of placing transportable Electronic Proximity Alarm Devices in each city police car plus a third-party device in offices of each school and the police station;
2. Only one Electronic Proximity Alarm Device located along the perimeter of a school property is necessary to activate the alarm system in the event of a proximity event, however transportable Models and fixed-in-place Models located in police cars and in school and police offices will simultaneously be notified of the time, place and direction of a proximity event thereby enabling immediate response and thus providing improved protection and security that would not otherwise be available;
3. Additionally, school teachers could wear mobile or transportable Models when chaperoning children on functions away from school grounds;
4. The effective range of fixed-in-place, mobile and transportable Models are set as determined by city council ordinances or by orders of the court;
5. Alternatively, police officers could wear mobile Models in lieu of transportable Models located in police cars; and
6. Furthermore, offenders must wear locked court ordered Units, whereas police officers and others may choose to wear Models that are not lockable.

### Descriptive Scenario

Example #2 of the usefulness and operational effectiveness of the Electronic Proximity Alarm Device.
1. A women's estranged husband is under a court order or other legal edict to stay a given distance away from his wife and he is required to wear a mobile Electronic Proximity Alarm Device at all times as ordered by the court;
2. The wife also wears a corresponding mobile Model as do each of their three children;
3. The Models worn by the wife and children will each respond to the husband's Unit, but they will not activate an alarm in response to each other's Models;
4. When the husband comes within a given distance of his wife or any of the children, as set by order of the court, the vibrator located within each Model as well as the husband's Unit will activate to alert the husband, the wife and any of the children, thereby alerting them that the proximity range has been breached, thus giving both husband, wife or any of the children the opportunity to increase the distance between them, thereby avoiding a proximity event;
5. In the event that the distance decreases to within a secondary range set by the court, the vibrations will cease, the audio alarms will activate and the volume will increase proportionally as the distance is reduced;
6. The affected Model(s) and the husband's Unit will signal a proximity breach to the closest law enforcement agency and law enforcement officers and they will receive significant information such as who are involved, the time of day, the exact location, distance and direction to where the breach is taking place and the nature of the potential offence will be transmitted simultaneously so that the officers may immediately answer the call;
7. The court may also order the placement of a fixed-in-place Electronic Proximity Alarm Device at the residence of the wife for the purpose of restricting the husband from entering the property and the fixed-in-place Model will only interact with the husband's Model and will only notify law enforcement agencies and officers or other third-party correspondents if so ordered by the court.

### Descriptive Scenario

Example #3 of the usefulness and operational effectiveness of the Electronic Proximity Alarm Device.
1. A convicted rapist has served his time and is paroled under court order or other legal edicts to wear the Electronic Proximity Alarm Device for the rest of his life;
2. Shortly after being released, he strikes again;
3. The victim is not shielded by the Electronic Proximity Alarm Device, therefore no help is summoned and she is raped and murdered;
4. Months later the body is discovered and detectives have no clues from the scene where the body was found;
5. The detectives turn to the Electronic Proximity Alarm Device data bank that tracks every movement of every Electronic Proximity Alarm Device being worn by a person under court order or other legal edicts and search the global positioning system coordinates to determine if an Electronic Proximity Alarm Device was at the scene where the body was discovered and they get a hit; and
6. The data bank provides the date and time that the device was at the scene together with other pertinent information as well as the present location of that particular Unit virtually anywhere in the world.

### Special Notes:

Any person that is under court order or other legal edicts to wear the Electronic Proximity Alarm Device will know that if the device is compromised, authorities will automatically be notified and the police will be on their way and if it was intentionally tampered with, he or she will soon be back in jail, therefore such persons will be unlikely to incapacitate their device.

Law enforcement personnel may set their Electronic Proximity Alarm Devices to respond to one or more types of infractions associated with court ordered devices, thereby providing themselves with the capability of canvassing areas where habitual violators would be most likely to commit a criminal act.

### Descriptive Scenario

Example #4 of the usefulness and operational effectiveness of the Electronic Proximity Alarm Device.
1. Seven gang members are convicted of severely beating a member of another gang and they are faced with jail time;
2. The judge is aware that the offense is the first infraction of the law for six of the seven gang members and the seventh member is a habitual offender, so he sends the seventh member to jail and offers the other offenders an opportunity to avoid jail in response to a plea agreement requested by their attorney on contingent that they each wear the Electronic Proximity Alarm Device and all six accept the offer;
3. The judge issues an order that their Units be set to restrict each gang member from coming within 500 feet from each other, but there is a problem; two gang members live in the same building and two other gang members live across and down the street from one another;
4. The judge orders the devices of the gang members that live in the same building to be modified to allow a buffer zone of 250 feet from the center of the building wherein the Units will not activate, thus allowing just these two gang members to cross paths only within the buffer zone;
5. The judge also orders a similar modification to the Units worn by the gang members that live across the street from one another, whereby a buffer zone of one-third of the distance between the homes is allowed and this modification has the effect that each of the gang members must leave their home and go in opposite directions, otherwise a proximity alarm will be activated; and
6. The judge pats himself on the back and makes a notation in his log that his decisions will save tens of thousands of dollars that would otherwise be spent on incarceration of the offenders.

### Special Note:

When gang members can't hang together and their every movement may be tracked if so ordered by the court the gangs should significantly dissipate.

### Descriptive Scenario

Example #5 of the usefulness and operational effectiveness of the Electronic Proximity Alarm Device.
1. A single mother has three children, two girls ages 11 and 12, and a boy age 14; she has a demanding, but lucrative job, however, she is overwhelmed with concerns about the security of her children, so she acquires four mobile Electronic Proximity Alarm Devices for herself and the children;
2. Each of the children's Models are set to activate in the event of a proximity event involving a habitual abductor, pedophile, rapist, drug dealer or child abuser and the mother's model is set only to activate in the event that a proximity event occurs that involves a habitual stalker, rapist, robber or an automobile high-jacker;
3. She also acquires a fixed-in-place Electronic Proximity Alarm Device that is tied into her home security system so that in the event of a break-in instead of going through a middleman, law enforcement agencies and officers will automatically be notified.
4. Now, the mother can sleep better because she knows that her children are safer than ever before and she can keep track of each child's whereabouts by utilizing the inquiry button located in or on her Electronic Proximity Alarm Device.

### Descriptive Scenario

Example #6 of the usefulness and operational effectiveness of the Electronic Proximity Alarm Device.
1. A prostitute is plying her trade on a popular corner in a sordid part of town;
2. She is wearing a white mini-skirt, white armless shirt, short white boots, a little white cap and a white armband;
3. The white armband is an Electronic Proximity Alarm Device that she bought herself;
4. A car pulls up close to the curb and after a moment or two, she gets in the car and gives the driver instructions to turn right at the next corner, but he doesn't turn.
5. Without losing her cool, she presses the panic button on her EPAD Model and very shortly three police cars show up and the police officers make multiple arrests, two for engaging in prostitution and one for attempted kidnapping; and
6. The kidnapping charge leads to a serial rapist/murder investigation.

### Descriptive Scenario

Example #7 of the usefulness and operational effectiveness of the Electronic Proximity Alarm Device.
1. A habitual drug pusher is released on parole on the contingency that he must wear an Electronic Proximity Alarm Device.
2. He's no fool, he takes the deal; he knows that his EPAD Unit is designed to activate when it comes within a minimum distance of a corresponding Electronic Proximity Alarm Device worn by another paroled drug dealer; he knows because the cops told him so; no big deal, he'll just do business with drug dealers that aren't wearing the device;
3. What he doesn't know is that the Electronic Proximity Alarm Devices worn by law enforcement personnel may not sound a audible alarm if programmed not to and will not cause his Unit to activate, therefore he will not be informed of their presence;
4. He also may not know that his travels may be tracked and recorded and that detectives may, with court order, observe his activities in real time while photographing and audio recording him and his new found friends;
5. A number of his former ‘friends’, users all, may also be wearing court ordered Units, thereby limiting his sales.

### Special Notes:

1. Electronic Proximity Alarm Devices worn by Law enforcement detectives may be programmed by the wearer to set the minimum distance range to allow pinpoint accuracy as to the distance and direction of a specific Unit they are tracking. Only authorized programmers may set other Electronic Proximity Alarm Devices.
2. Every Electronic Proximity Alarm Device may be set by programmers to meet requirements specified by court order or to meet requirements requested by individuals who acquire the device for security purposes, so long as such requests are not inappropriate and they comply with the law.
3. Court orders are required to access information from Electronic Proximity Alarm Device data banks.

### Descriptive Scenario

Example #8 of the usefulness and operational effectiveness of the Electronic Proximity Alarm Device.
1. The general manager of a huge mall in a bustling metropolitan area was being hammered by her tenants because of an over-abundance of pickpockets and shoplifters that were causing them great losses by theft and by costs incurred to provide sufficient security personnel;
2. She, in turn, had been hammering the mayor, the Chief of Police, the city council and a bunch of other poor souls including her husband!
3. Then, a traveling salesman tells her about another mall that doesn't seem to have such problems because of a newfangled device they call EPAD or Electronic Proximity Alarm Device.
4. A short time latter, Fixed-in Place EPAD Models were installed along the perimeter of the mall building and the range of coverage extended to within the property lines;
5. The lady didn't hold back, the Models were programmed to cover habitual pickpockets, shoplifters, pedophiles, drug dealers, drug users and robbers that were court ordered to wear such EPAD Units, each being specific as to the infraction perpetrated by each offender.
6. The Chief of Police notified the court, the court notified the city council and the city council passed ordinances to allow the courts to require Electronic Proximity Alarm Devices as a part of their sentences; and
7. Over a relatively short time, crimes in the mall were reduced to a trickle and everyone lived happily ever after.

### Special Note:

The above stories are just examples of what we may expect to become true stories in the foreseeable future, but the strength of the invention lies in the fact that all of the components comprising the current art have been patented in the past in one way or another, thereby proving their value and offering a new beginning by being assembled together at a time when they are needed most.

### CONCLUSIONS, RAMIFICATIONS AND SCOPE

### Conclusions

One must conclude from the information provided above that we are in dyer need to provide means, methods and systems whereby law enforcement agencies such as local police departments, county sheriff deputies, highway patrol officers, the FBI, CIA, ATF and HSA may improve their operations and efficiency in order to shield and protect innocent people from criminal acts perpetrated by habitual criminals on parole or probation;

One must conclude that the judges of criminal courts must be equipped with means, methods and systems whereby they may tailor their sentences in such manner that they will provide opportunities for decreasing future criminal acts, controlling the activities of habitual criminals, shielding and protecting potential victims, assisting law enforcement agencies and personnel in the prosecution of their duties and reducing the financial costs and losses incurred by the private and public sectors due to rampant criminal acts in virtually every community in this great nation; and

One must conclude that the innocent, honest and productive people in this country have the right to be shielded and protected from the actions of habitual criminals.

### Ramifications

Whereas the current art, Electronic Proximity Alarm Device, provides the means, methods and systems required to assist the courts and law enforcement agencies in shielding and protecting the populous from future habitual criminal acts; and

Whereas a judge must issue a court order to allow a habitual criminal to wear a EPAD Unit and the habitual criminal has the option of wearing said Unit or being incarcerated for the full term of his or her sentence; and

Whereas the general populous may wear EPAD Models of their own volition and for their own security and well-being, one must agree that the result will be for the overall good and welfare of all the people.

### Scope

The Electronic Proximity Alarm Device is essentially a control device whereby habitual criminals are provided with an EPAD Unit for the purpose of maintaining court ordered or other legal edicts regarding given minimum allowable proximity between habitual criminals and potential victims;

The Electronic Proximity Alarm Device utilizes one or more radio transmission and receiving devices in conjunction with one or more radio frequencies to determine whether the given minimum allowable proximity set by the court or other legal edicts have been breached, thus causing a proximity event and triggering one or more alarms to be transmitted to law enforcement agencies and law enforcement officers, thereby allowing immediate response to a possible criminal act; and

The Electronic Proximity Alarm Device provides and promotes the means, methods and systems whereby the people may actively participate with community leaders, the courts, law enforcement agencies and their personnel to reduce crime as well as costs associated with crime.

### Special Note:

The Electronic Proximity Alarm Device is comprised of housings that may be produced in one or more shapes, sizes, materials and finishes and is further comprised of numerous components that have been known, produced, manufactured, advertised, published or patented in one form or another prior to Sep. 16, 1985 and has been described herein in a number of different ways for the purpose of clearly conveying the true worth, essence and breadth of the invention.

Furthermore, there are an unlimited number of Units and Models as well as unlimited numbers of combinations of components, systems and programs comprising the invention, therefore no statements herein shall be construed to limit the scope of the invention in any way what-so-ever.

I claim:

1. An Electronic Proximity Alarm Device comprising a housing that covers and protects one or more electronic and mechanical components that are assembled within the housing and that are electronically programmed in such manner as to wirelessly determine whether one and another of the Devices are within given minimum allowable proximity of each other, in which case an alarm is triggered for the purpose of notifying users of the Devices and corresponding third parties that a proximity breach is in progress at a specific place, in a specific direction and at specific distances from each of the corresponding and third-party Devices.

2. The Electronic Proximity Alarm Device according to claim 1 further comprising an unlimited number of Electronic Proximity Alarm Device Units and Models of unlimited numbers of sizes, shapes, finishes and materials of manufacture including, but not limited to those that may circumscribe human and other animal body parts such as necks, wrists, waists and ankles as well as those that may be transportable or fixed-in-place.

3. The Electronic Proximity Alarm Device according to claim 1 further comprising one or more radio technology devices including, but not limited to electronic circuits, systems and programs capable of wirelessly transmitting and receiving signals and messages to and from corresponding Electronic Proximity Alarm Devices and third party Devices.

4. The Electronic Proximity Alarm Device according to claim 1 further comprising a rechargeable electrical power source, but not limited to Voltaic Cells, a power source that provides electrical energy generated by body movement, solar power or alternative sources of electrical power.

5. The Electronic Proximity Alarm Device according to claim 1 further comprising computer hardware and software, but not limited to electronic microprocessors, computer chips, programmable software, and programs specifically relating to the operations of electronic and mechanical components within the Electronic Proximity Alarm Device housing.

6. The Electronic Proximity Alarm Device according to claim 1 further comprising one or more electronic and mechanical alarm devices, programs and systems including, but not limited to vibration and audio alarm capabilities;

7. The Electronic Proximity Alarm Device according to claim 1 further comprising at least one global positioning system, GPS, including, but not limited to an atomic clock and computer programs that utilize the global positioning system.

8. The Electronic. Proximity Alarm Device according to claim 1 further comprising one or more electrical circuitry layouts and one or more placement relationships of components located within the housing.

9. The Electronic Proximity Alarm Device according to claim 1 further comprising a panic button with a pressure sensitive capability and an electronic means of alerting third party corresponding devices utilizing direct radio transmissions, relay towers and GPS to contact police and other emergency services.

10. The Electronic Proximity Alarm Device according to claim 1 further comprising a panic button that utilizes a cellular phone to contact police and other emergency services.

11. The Electronic Proximity Alarm Device according to claim 1 further comprising a Liquid Crystal Display or a Touchscreen Display mounted on or let into the surface of the Electronic Proximity Alarm Device housing whereby the direction and distance of one or more corresponding Devices may be displayed together with additional information written in one or more languages or, alternatively the same information described verbally in one or more languages to accommodate the blind.

12. The Electronic Proximity Alarm Device according to claim 1 further comprising an inquiry button including, but not limited to a pressure sensitive device and an electronic switch for the purpose of determining the location of a corresponding Electronic Proximity Alarm Device.

13. The Electronic Proximity Alarm Device according to claim 1 further comprising a software program whereby each component within the Electronic Proximity Alarm Device housing may be turned on or off independently of the other components.

14. The housing according to claim 1 further comprising engraved information on the exterior of the housing identifying the name, address and telephone number of the wearer of a specific Electronic Proximity Alarm Device.

15. The Electronic Proximity Alarm Device according to claim 1 further comprising one or more electronic ports to accommodate other electronic devices and accessories including, but not limited to recharging a voltaic cell.

16. The Electronic Proximity Alarm Device according to claim 1 further comprising an electronic calculator programmed to utilize information received from wireless transmissions including, but not limited to the global satellite positioning system, direct radio broadcasts based on strength of signals and radio transmission triangulation programs for the purpose of determining the distance between two or more Electronic Proximity Alarm Devices, perimeter dimensions of specific areas within three or more GPS coordinates and further determining where one or more Electronic Proximity Alarm Devices are at a given time and date for tracking and recording where one or more Electronic Proximity Alarm Devices have been at any prior time and date.

17. The Electronic Proximity Alarm Device according to claim 1 further comprising one or more electronic software programs capable of sending and receiving messages, data and commands to and from corresponding Electronic Proximity Alarm Devices and third-party corresponding devices including, but not limited to law enforcement agencies, law enforcement officers, detectives and proprietary data banks.

18. The Electronic Proximity Alarm Device according to claim 1 further comprising an electronic alphanumeric pressure sensitive keyboard pager.

19. The Electronic Proximity Alarm Device according to claim 1 further comprising a digital camera with video capability.

20. Reserved, the applicant being pro se, for the examiner to write a claim in behalf of the inventor in the event that claim 1 is denied and the invention is deemed to be patentable.
